(19) United States
(12) Patent Application Publication
(10) Pub. No.: US 2014/0036360 A1
(43) Pub. Date: Feb. 6, 2014

(54) DISPLAY UNIT AND ELECTRONIC APPARATUS

(71) Applicant: Sony Corporation, Tokyo (JP)

(72) Inventors: Sho Sakamoto, Tokyo (JP); Yutaka Imai, Tokyo (JP)

(73) Assignee: Sony Corporation, Tokyo (JP)

(21) Appl. No.: 13/952,121

(22) Filed: Jul. 26, 2013

(30) Foreign Application Priority Data
Aug. 6, 2012 (JP) 2012-174277

(51) Int. Cl. G02B 27/22

(52) U.S. Cl. CPC G02B 27/2214
USPC 359/463; 359/462

(57) ABSTRACT

A display unit includes: a display section including a plurality of pixels and a black matrix formed between the adjacent pixels, and displaying n-number of perspective images having respective perspectives through allocating the n-number of perspective images to n-number of adjacent pixels, respectively, where n is an integer of 2 or larger; and a parallax device including a plurality of separation elements, two or more adjacent separation elements of the plurality of separation elements being arranged in correspondence with the n-number of adjacent pixels, the parallax device separating the n-number of perspective images into respective n-number of directions. A single specific separation element of the two or more adjacent separation elements allows a single specific perspective image of the plurality of perspective images to be viewed from a specific perspective position, and the rest allow the black matrix to be viewed from the specific perspective position.

### BACKGROUND

The present disclosure relates to a display unit performing stereoscopic display based on a naked-eye scheme with the use of a parallax device, and to an electronic apparatus that includes such a display unit.

Methods for performing stereoscopic display include an eyeglasses scheme that uses eyeglasses for stereoscopic vision and a naked-eye scheme that achieves stereoscopic vision with naked eyes without using the special eyeglasses for stereoscopic vision. Typical methods of the naked-eye scheme are a parallax barrier scheme and a lenticular lens scheme. In the parallax barrier scheme and the lenticular lens scheme, a plurality of perspective images (perspective images for respective right and left eyes, in a case of two perspectives) for stereoscopic vision are displayed space-divisionally on a display section (two-dimensional display panel), and the displayed perspective images are separated in a horizontal direction by the parallax device. Thus, stereoscopic vision is achieved. In the parallax barrier scheme, a parallax barrier that includes slit-like opening sections is used as the parallax device. In the lenticular lens scheme, a lenticular lens that includes a plurality of cylindrical lens elements arranged side by side is used as the parallax device.

### SUMMARY

However, in the above-described naked-eye scheme, an arrangement position (a distance from the display section) of the parallax device is fixed at a specific position depending on design conditions such as a viewing distance. For example, Japanese Unexamined Patent Application Publication No. 2005-92103 discloses a display unit capable of allowing a barrier width and a barrier position in an in-plane direction of the parallax barrier to be varied according to the viewing distance. However, the distance from the display section is fixed. On the other hand, in some cases, it is favorable to arrange the parallax device at a position different from the position determined depending on the design conditions. For example, when it is favorable to reduce a thickness of whole of the unit, it may be necessary to arrange the parallax device at a position closer to the display section than the position determined depending on the design conditions. In contrast, when it is favorable to increase the thickness of the whole of the unit, it is necessary to arrange the parallax device at a position farther from the display section than the position determined depending on the design conditions. For example, in order to keep the distance between the parallax device and the display section to be uniform, a spacer made of a material such as glass may be inserted therebetween in some cases. However, in that case, a spacer with larger thickness is necessary as the distance between the parallax device and the display section is increased, and therefore, the weight of the whole of the unit is increased. Accordingly, it may be preferable that the parallax device be arranged at a position close to the display section. On the contrary, when it is difficult to reduce the thickness of the unit in the manufacturing due to reasons such as an increase in resolution of the display section, it may be preferable to arrange the parallax device at a far position. However, when the parallax device is intended to be arranged at a position closer to (or farther from) the position determined depending on the design conditions, for example, an issue that the viewing distance becomes shorter (or longer) etc. may occur.

It is desirable to provide a display unit and an electronic apparatus that are capable of allowing arrangement of a parallax device to be varied without changing viewing conditions such as a viewing distance.

According to an embodiment of the present disclosure, there is provided a display unit including: a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another. A single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.

According to an embodiment of the present disclosure, there is provided an electronic apparatus with a display unit, the display unit including: a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another. A single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.

In the display unit and the electronic apparatus according to the above-described embodiments of the present disclosure, a single specific separation element of the two or more adjacent separation elements allows a single specific perspective image of the plurality of perspective images to be viewed from a specific perspective position, and the rest of the two or more adjacent separation elements allow the black matrix to be viewed from the specific perspective position.

According to the display unit and the electronic apparatus of the above-described embodiments of the present disclosure, two or more adjacent separation elements are arranged in correspondence with the adjacent pixels for the n-number of perspectives, and the black matrix is viewed through separation elements other than the specific separation element. Therefore, the arrangement of the parallax device is allowed to be varied without changing the viewing conditions such as the viewing distance.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating a configuration example of a display unit according to a first embodiment of the present disclosure.

FIG. 2 is a cross-sectional view illustrating a relationship between pixels, a parallax device (lenticular lens), and perspective positions in a design method of a comparative example.

FIG. 3 is a cross-sectional view illustrating a relationship between the pixels, a parallax device (parallax barrier), and the perspective positions in the design method of the comparative example.

FIG. 4 is a cross-sectional view illustrating a configuration example of the parallax device in the design method of the comparative example.

FIG. 5 is a cross-sectional view illustrating a relationship between pixels, a parallax device, and perspective positions in the display unit according to the first embodiment.

FIG. 6 is an enlarged view of part of FIG. 5.

FIG. 7 is an explanatory diagram illustrating a design method of the parallax device when the parallax device is arranged at a position A1 in FIG. 1.

FIG. 8 is an explanatory diagram illustrating configuration conditions of the pixels when the parallax device is arranged at the position A1 in FIG. 1.

FIG. 9 is an explanatory diagram illustrating the configuration conditions of the pixels when the parallax device is arranged at the position A1 in FIG. 1.

FIG. 10 is an explanatory diagram illustrating a design method of the parallax device when the parallax device is arranged at a position A2 in FIG. 1.

FIG. 11 is an explanatory diagram illustrating a design method of the parallax device when the parallax device is arranged at a position A in FIG. 1.

FIG. 12 is an explanatory diagram illustrating the design method of the parallax device when the parallax device is arranged at the position A in FIG. 1.

FIG. 13 is an explanatory diagram illustrating the design method of the parallax device when the parallax device is arranged at the position A in FIG. 1.

FIG. 14 is an explanatory diagram illustrating the design method of the parallax device when the parallax device is arranged at the position A in FIG. 1.

FIG. 15 is an explanatory diagram illustrating the design method of the parallax device when the parallax device is arranged at the position A in FIG. 1.

FIG. 16 is an explanatory diagram illustrating a design method of the parallax device when the parallax device is arranged at a position B in FIG. 1.

FIG. 17 is an explanatory diagram illustrating the design method of the parallax device when the parallax device is arranged at the position B in FIG. 1.

FIG. 18 is an explanatory diagram illustrating the design method of the parallax device when the parallax device is arranged at the position B in FIG. 1.

FIG. 19 is an explanatory diagram illustrating the design method of the parallax device when the parallax device is arranged at the position B in FIG. 1.

FIG. 20 is an explanatory diagram illustrating the design method of the parallax device when the parallax device is arranged at the position B in FIG. 1.

FIG. 21 is a cross-sectional view illustrating a configuration example of a display unit according to a second embodiment.

FIG. 22 is a cross-sectional view illustrating a configuration example of a parallax device in a design method of a comparative example.

FIG. 23 is an explanatory diagram illustrating a design method of the parallax device when the parallax device is arranged in a position A in FIG. 21.

FIG. 24 is an explanatory diagram illustrating a design method of the parallax device when the parallax device is arranged at a position B in FIG. 21.

FIG. 25 is an appearance diagram illustrating an example of an electronic apparatus.

### DETAILED DESCRIPTION

Preferred embodiments of the present disclosure will be described below in detail with reference to the drawings. Description will be given in the following order.

### 1. First Embodiment

a configuration example in which a parallax device is arranged in the front

### 2. Second Embodiment

a configuration example in which the parallax device is arranged on the rear

### 3. Other Embodiments

a configuration example of an electronic apparatus, etc.

### 1. First Embodiment

### [General Configuration of Display Unit]

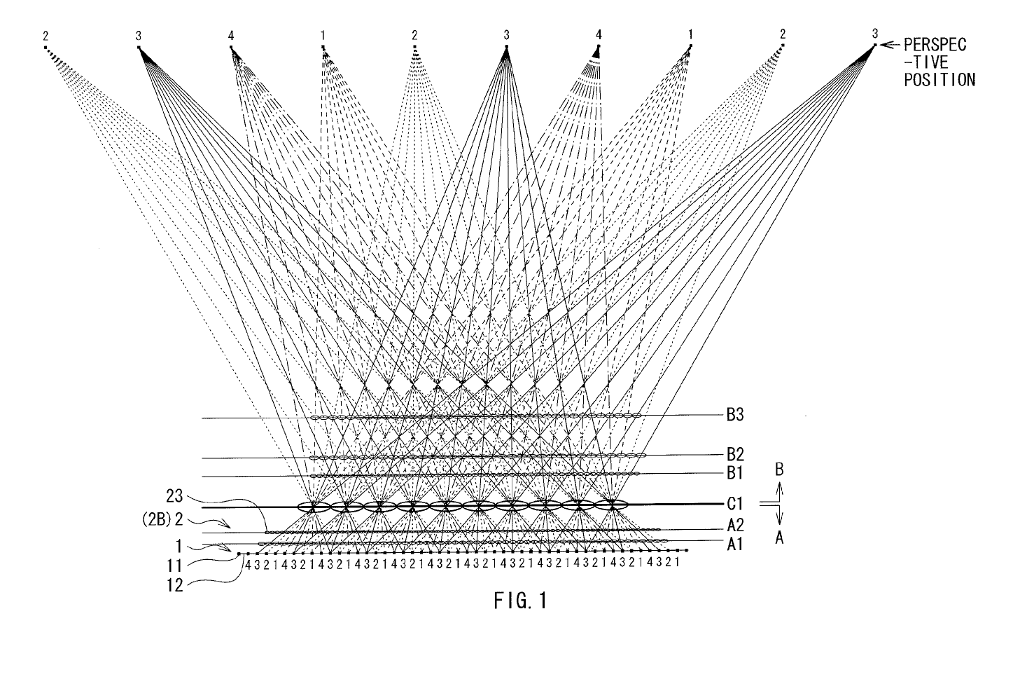

FIG. 1 illustrates a configuration example of a display unit according to an embodiment of the present disclosure. The display unit includes a display section 1 and a parallax device 2. By a design method which will be described later, in the display unit, an arrangement of the parallax device 2 is allowed to be varied without changing viewing conditions such as a viewing distance Z. In other words, an arrangement position of the parallax device 2 may take various forms. In FIG. 1, the arrangement position of the parallax device 2 in a typical design method is shown by C1. Also, examples of possible arrangement positions in the later-described design method according to the present embodiment are shown by A1, A2, B1, B2, and B3. By the design method according to the present embodiment, the parallax device 2 is allowed to be arranged at a position A that is closer to the display section 1 than the position C1 or at a position B that is farther from the display section 1 than the position C1.

In a display screen of the display section 1, a plurality of pixels 11 are arranged two-dimensionally. A black matrix 12 is formed between the adjacent pixels 11 in the display section 1. The plurality of pixels 11 in the display section 1 are each provided with the number from 1 to n (n is an integer that is 2 or larger). A plurality of perspective images for the n-number of perspectives are allocated to different pixels to be displayed thereon. It is to be noted that FIG. 1 shows an example in which n is 4.

In the display section 1, each of the plurality of pixels 11 may preferably have an effective width that is sufficiently small as will be described later. Therefore, the display section 1 may be preferably configured, for example, of an LED (Light Emitting Diode) display that allows the effective width of each pixel 11 to be sufficiently small. Other than this, the display section 1 may be configured of a two-dimensional display such as a liquid crystal display panel, an electroluminescence display panel, and a plasma display.

The display unit performs stereoscopic display based on a naked-eye scheme. A stereoscopic display scheme of the display unit may be a scheme that uses the parallax device 2, for example, of a parallax barrier scheme, a lenticular lens scheme, etc. The display section 1 displays a parallax composite image in which parallax images (perspective images) for a plurality of perspectives are combined in one screen. In other words, the plurality of perspective images are displayed in a space-divisional manner. The parallax device 2 includes a plurality of separation elements and separates the respective perspective images displayed on the display section 1 into directions different from one another.

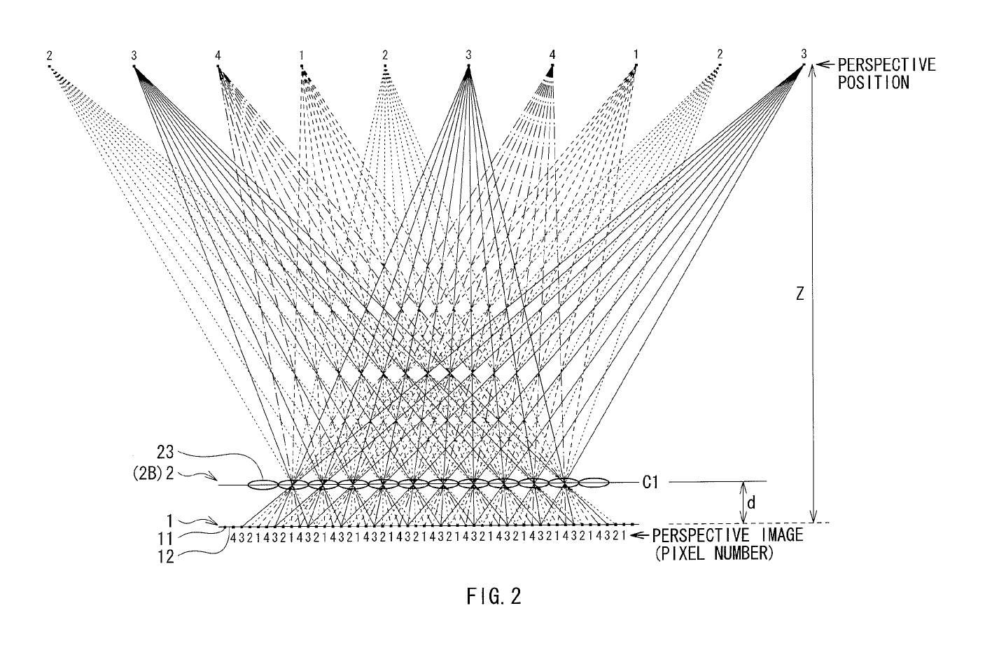

In the lenticular lens scheme, for example, as shown in FIG. 2, a lenticular lens 2B in which, for example, a plurality of cylindrical lens elements 23 (separation elements) may be arranged side by side may be used as the parallax device 2. It is to be noted that FIG. 2 illustrates a configuration example in a case where the lenticular lens 2B is arranged at an arrangement position C1 in a typical design method. The lenticular lens 2B spatially separates the plurality of perspective images displayed on the display section 1 to emit the perspective images toward a viewer. Thus, the respective perspective images displayed on the display section 1 are separated into different directions and different perspective images reach respective left and right eyes of the viewer, which achieves stereoscopic vision. The lenticular lens 2B may be a variable lens. For example, the lenticular lens 2B may be a lens in which a lens effect thereof is electrically turned on or off such as a liquid crystal lens. In this case, a mode is selectively switched between a full-screen two-dimensional (2D) display mode and a full-screen three-dimensional (3D) display mode in any way.

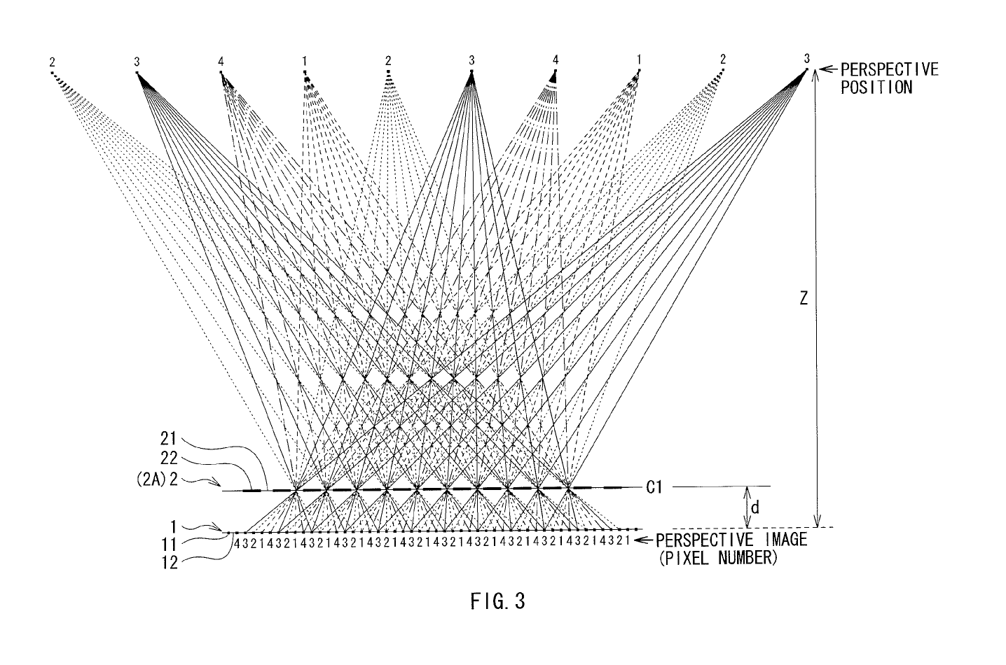

In the parallax barrier scheme, for example, as shown in FIG. 3, a parallax barrier 2A may be used as the parallax device 2. It is to be noted that FIG. 3 illustrates a configuration example in a case where the parallax barrier 2A is arranged at the arrangement position C1 in the typical design method. The parallax barrier 2A includes opening sections 21 (separation elements) that transmit light and shielding sections 22 that block light. The parallax barrier 2A spatially separates the plurality of perspective images displayed on the display section 1 to emit the perspective images toward a viewer. Thus, the respective perspective images displayed on the display section 1 are separated into different directions and different perspective images reach respective left and right eyes of the viewer, which allows stereoscopic vision. The parallax barrier 2A may be, for example, of a fixed type or of a variable type. When the parallax barrier 2A is of the fixed type, for example, a transparent parallel plane plate (base) that has a surface provided with a pattern of the opening sections 21 and the shielding sections 22 formed, for example, of thin-film metal may be used. When the parallax barrier 2A is of the variable type, for example, a display function (light modulation function) by a liquid crystal display device of a backlight scheme may be used to selectively form the pattern of the opening sections 21 and the shielding sections 22. In this case, a mode is selectively switched between a full-screen two-dimensional (2D) display mode and a full-screen three-dimensional (3D) display mode in any way, as in the above-described case of using the variable lens as the lenticular lens 2B.

Hereinbelow, the design method of the case of using the lenticular lens 2B as the parallax device 2 is basically described in the present embodiment. However, a similar design method is applicable to the case of using the parallax barrier 2A as well.

### [Configuration Example of Parallax Device 2 in Comparative Example (Typical Design Method)]

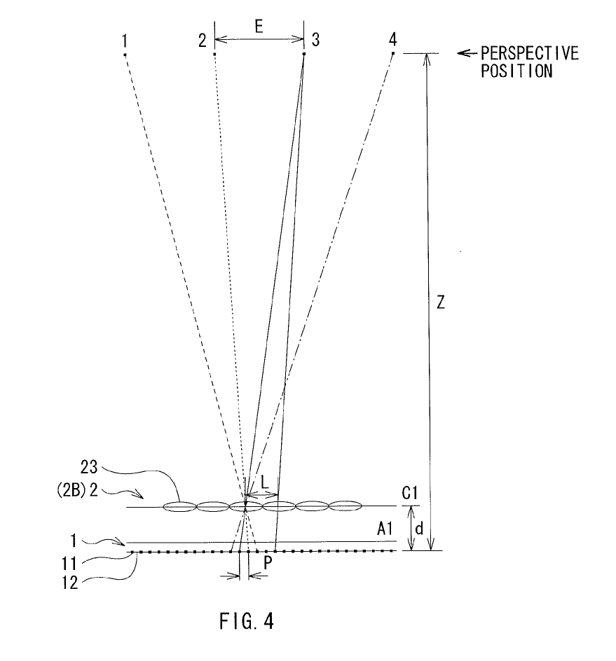

As a comparative example, description will be given of a configuration example of the parallax device 2 (lenticular lens 2B) in a typical design method referring to FIG. 4. In the typical design method, a distance d between the display section 1 and the parallax device 2 is designed as follows. Further, an arrangement interval (an arrangement interval between two adjacent lens elements 23, in FIG. 4) L of the separation elements in the parallax device 2 is designed as follows. It is to be noted that the arrangement interval L of the separation element corresponds to an arrangement interval of two adjacent opening sections 21 (see FIG. 3) in the case where the parallax device 2 is the parallax barrier 2A.

d=Z·P/(E+P)

L=nP·E/(E+P)

In the above-described expressions, n is the number of perspectives, Z is the viewing distance, E is an interocular distance, and P is a pixel pitch.

When the distance d and the arrangement interval L are used as design values, one separation element is arranged with respect to the adjacent pixels 11 for the n-number of perspectives. For example, in a case of four perspectives, as in the example shown in FIG. 2, one lens element 23 is arranged with respect to the adjacent pixels 11 for four perspectives. The respective first to fourth perspective images displayed in the adjacent pixels 11 for four perspectives are separated into directions of different perspective positions by one lens element 23. The plurality of lens elements 23 are arranged. However, all of the lens elements 23 separate, in the same manner, the respective first to fourth perspective images displayed in the corresponding pixels 11 for four perspectives into directions of different perspective positions.

### [Configuration Example of Parallax Device 2 in Design Method According to Present Embodiment]

In contrast to the above-described typical design method, in the design method according to the present embodiment, two or more adjacent separation elements are arranged with respect to the adjacent pixels 11 for the n-number of perspectives. When viewed from a specific perspective position, a single specific perspective image is allowed to be viewed through a single specific separation element of the two or more adjacent separation elements. Further, the black matrix 12 that is formed near the adjacent pixels 11 for the n-number of perspectives is allowed to be viewed through separation elements other than the specific separation element. Moreover, as will be described later, an arrangement interval S of the separation elements in the parallax device 2 is set to a value smaller than the above-described arrangement interval L in the typical design method. In other words, the separation elements are arranged in a pitch that is smaller than the pitch in the above-described typical design method.

### [In Case of Arranging Parallax Device 2 at Position A1]

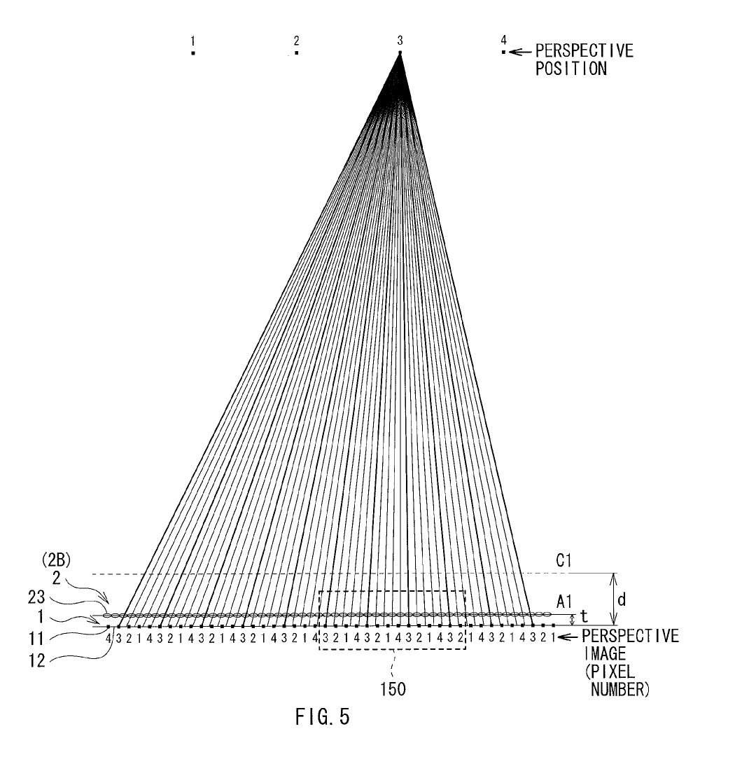

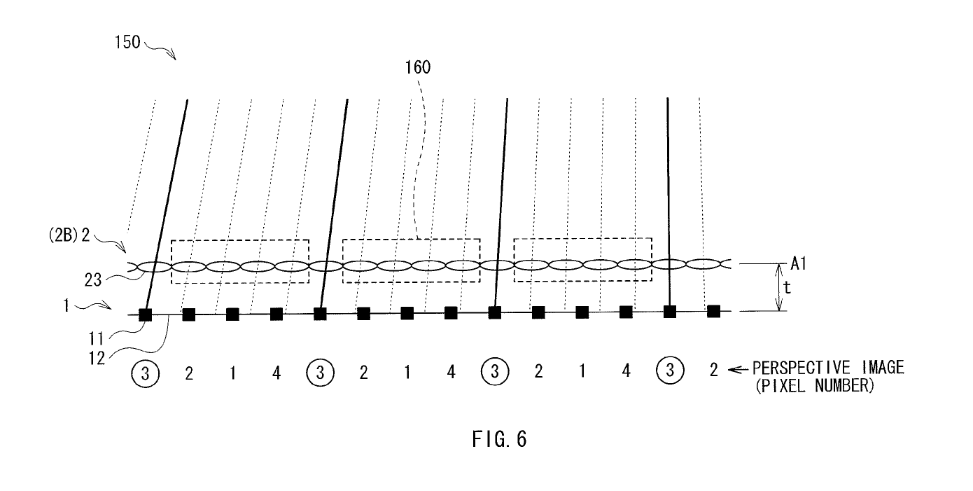

First, description will be given of an example in which the parallax device 2 (lenticular lens 2B) is arranged at the position A1 (see FIG. 1) that is closer to the display section 1 than the position C1 based on the typical design method. FIG. 5 illustrates a state in which the display section 1 is viewed from a specific perspective position (third perspective position) when the lenticular lens 2B is arranged at the position A1. A portion in a region 150 surrounded by a dashed line in FIG. 5 is shown in FIG. 6 in an enlarged fashion.

In the example shown in FIGS. 5 and 6, five lens elements 23 are arranged with respect to adjacent pixels 11 for four perspectives. When viewed from the third perspective position that is the specific perspective position, a single specific perspective image (third perspective image) is viewed through a single specific lens element 23 of the five adjacent lens elements 23. Also, the black matrix 12 formed near the adjacent pixels 11 for the four perspectives is viewed through lens elements 23 (lens in a region 160 in FIG. 5) other than the single specific lens element 23. As described above, when the parallax device 2 is arranged at the position C1, the specific perspective image is viewed through all of the lens elements 23. However, in the example shown in FIGS. 5 and 6, the specific perspective image is viewed only through part of the lens elements 23.

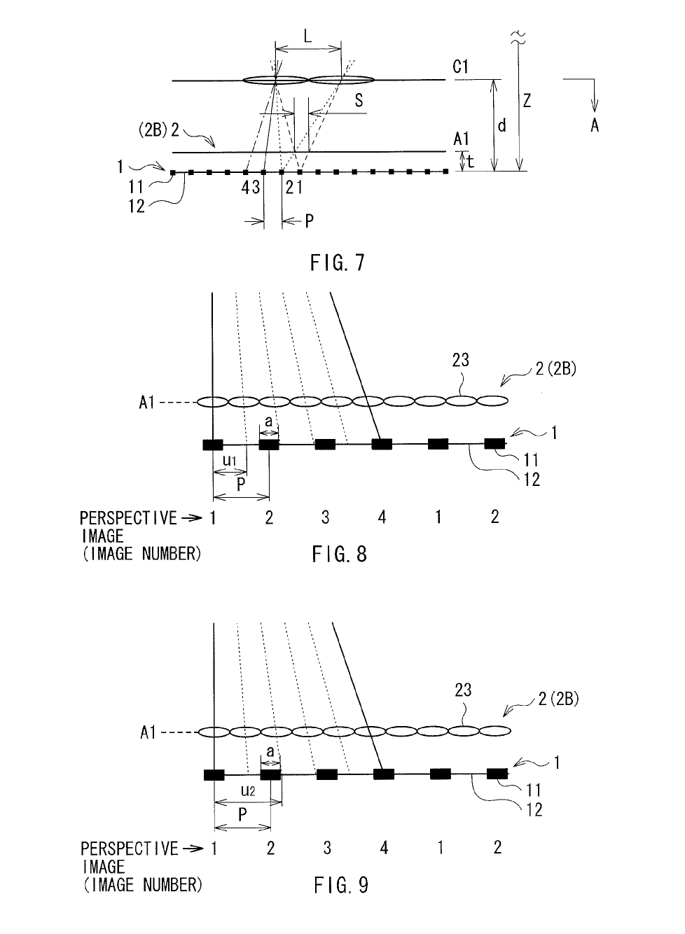

Referring to FIG. 7, description will be given of a design method for achieving the configuration example shown in FIGS. 5 and 6. A distance “t” between the display section 1 and the parallax device 2 is designed as follows. Further, the arrangement interval (arrangement interval of two adjacent lens elements 23) S of the separation elements in the parallax device 2 is designed as follows. It is to be noted that, when the parallax device 2 is the parallax barrier 2A, the arrangement interval S of the separation element corresponds to the arrangement interval of the two adjacent opening sections 21 (see FIG. 3). Further, in the case of using the parallax barrier 2A, each opening section 21 preferably has a size equal to or smaller than an effective width “a” of each pixel 11 which will be described later. This prevents occurrence of crosstalk.

t=Z·P/{E(n+1)+P}

S=nP·E/{E(n+1)+P}

In the above-described expressions, n is the number of perspectives, Z is the viewing distance, E is the interocular distance, and P is the pixel pitch.
[Condition of Effective Width “a” of Pixel 11]

Here, in order to achieve the viewing state as shown in the example in FIGS. 5 and 6, it is necessary to achieve the state in which the black matrix 12 is viewed through lens elements 23 (lens in the region 160 in FIG. 5) other than the specific lens element 23. In order to achieve this, it may be necessary to allow the effective width “a” of the pixel 11 to be sufficiently small so as to satisfy the following condition in addition to the above-described conditions related to the distance “t” and the arrangement interval S. By satisfying this condition, occurrence of a so-called crosstalk is prevented in which an image different from a desired perspective image is viewed. When assuming that the lens elements 23 have an ideal light collecting function, a maximum allowable value of the effective width “a” of the pixel 11 not to cause crosstalk at the viewing position is as follows (see FIGS. 8 and 9).

As shown in FIGS. 8 and 9, it may be desirable to satisfy the following condition.

P−u₁>a/2,u₂−P>a/2, . . .

Therefore, the allowable value of the effective width a satisfies the following condition,

a<2·P{1−m/(n+1)} and a<2·P{m/(n+1)}

where m=1, 2, . . . , n.

### [In Case of Arranging Parallax Device 2 at Position A2]

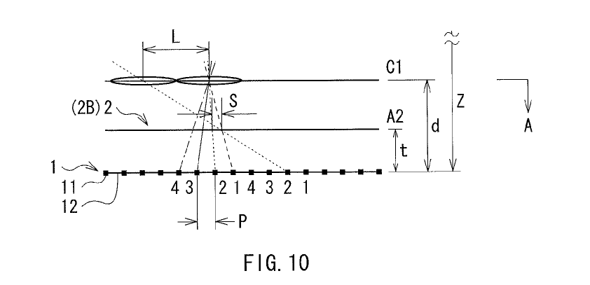

Similarly to the above-described design method for the position A1, when the parallax device 2 (lenticular lens 2B) is arranged at the position A2 (see FIG. 1), the distance “t” between the display section 1 and the parallax device 2 is designed as follows. Also, the arrangement interval (arrangement interval of the two adjacent lens elements 23) S of the separation elements in the parallax device 2 is designed as follows (see FIG. 10).

t=Z·P(n−1)/{E(2n−1)+P(n−1)}

S=nP·E/{E(2n−1)+P(n−1)}

### [In Case of Arranging Parallax Device 2 at Position B1]

Moreover, when the parallax device 2 (lenticular lens 2B) is arranged at the position B1 (see FIG. 1) that is located farther from the display section 1 than the position C1 based on the typical design method, the distance “t” between the display section 1 and the parallax device 2 is designed as follows. Also, the arrangement interval (arrangement interval of the two adjacent lens elements 23) S of the separation elements in the parallax device 2 is designed as follows.

t=Z·P(2n+1)/{E(n+1)+P(2n+1)}

S=nP·E/{E(n+1)+P(2n+1)}

[Unified Expression in Case of Arranging Parallax Device 2 at Position A (t<d)]

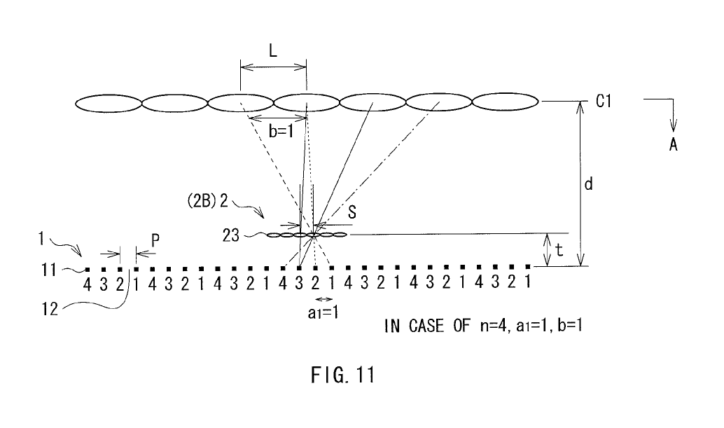

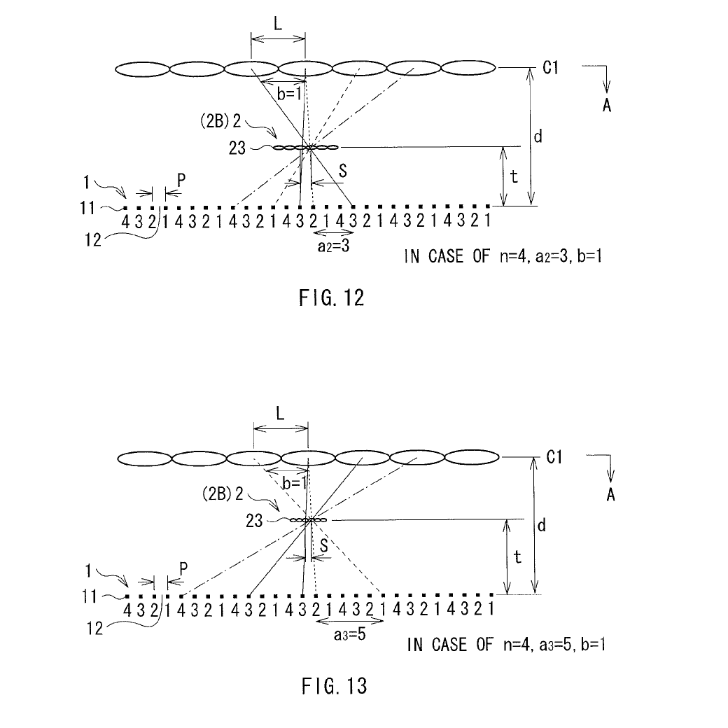

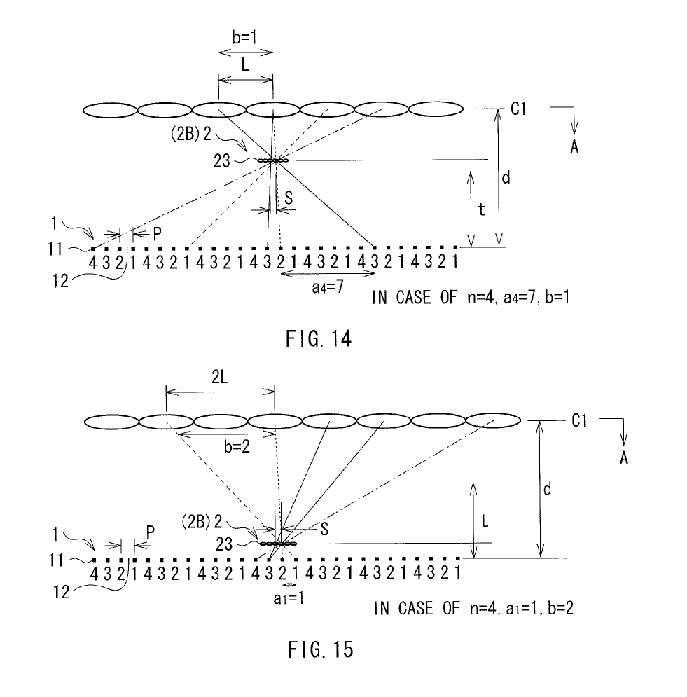

Referring to FIGS. 11 to 15, description will be given of a unified expression in the design method when the parallax device 2 is arranged at the position A that is closer to the display section 1 than the position C1 is. When the parallax device 2 is arranged at the position A (t<d), the distance “t” between the display section 1 and the parallax device 2 may be designed by the following unified expression. Further, the arrangement interval (arrangement interval of the two adjacent lens elements 23) S of the separation elements in the parallax device 2 is designed by the following unified expression. It is to be noted that FIG. 11 illustrates a case in which n=4, a₁=1, and b=1, FIG. 12 illustrates a case in which n=4, a₂=3, and b=1, FIG. 13 illustrates a case in which n=4, a₃=5, and b=1, FIG. 14 illustrates a case in which n=4, a₄=7, and b=1, and FIG. 15 illustrates a case in which n=4, a₁=1, and b=2.

t=Z·aₘP/{(bn+aₘ)E+aₘP}

S=nE·P/{(bn+aₘ)E+aₘP}

In the above-described expressions, the following is satisfied.

a₂ₘ₋₁=n(m−1)+1

a₂ₘ=nm−1

m=1, 2, 3, . . .

b=1, 2, 3, . . . .

As shown in FIGS. 11 to 15, each lens element 23 at the position A is arranged in each of the intersections of principal rays for the respective perspectives that connect the respective pixels 11 and the respective lens elements 23 at the position C1. In this case, the principal ray is allowed to connect each of the aₘ-number of pixels 11 and each of the b-number of lens elements 23 at the position C1.

[Unified Expression in Case of Arranging Parallax Device 2 at Position B (t>d)]

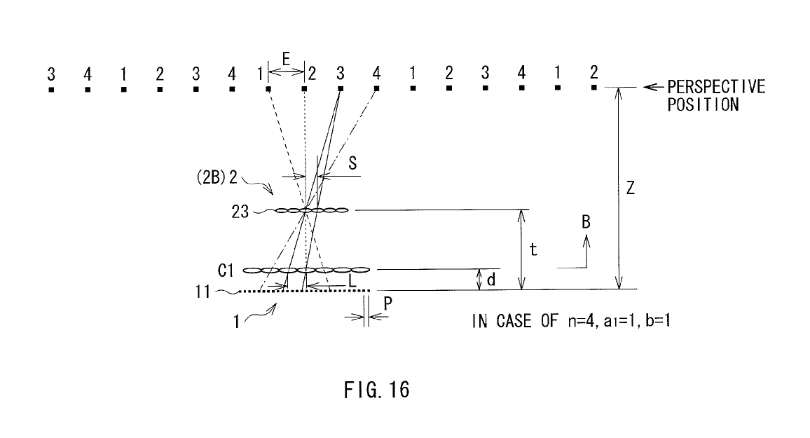

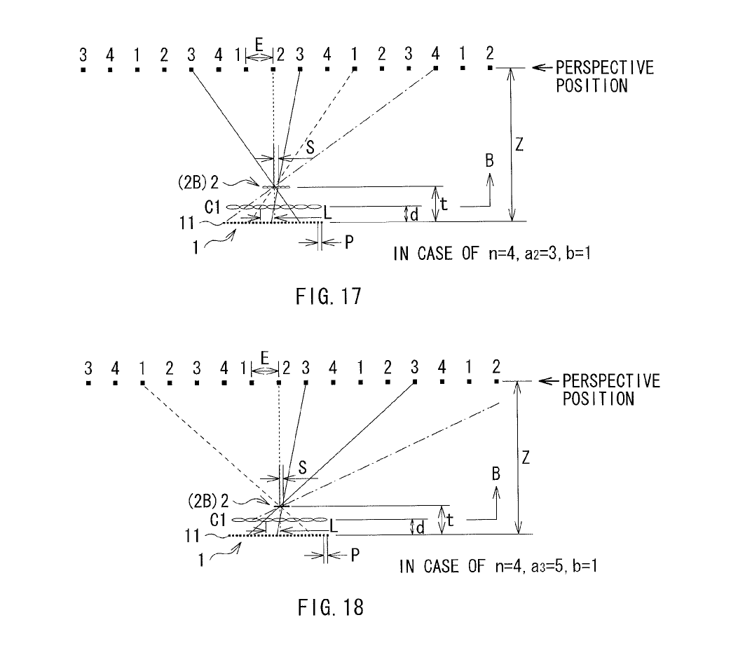

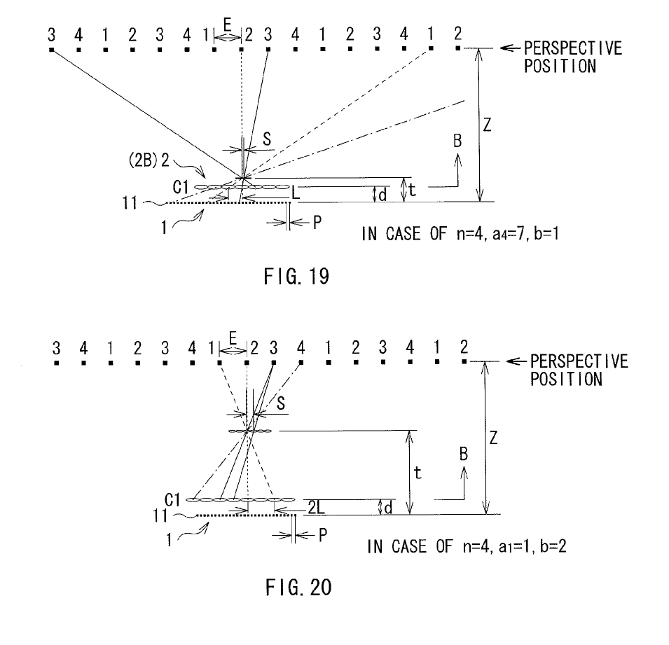

Referring to FIGS. 16 to 20, description will be given of a unified expression in the design method when the parallax device 2 is arranged at the position B that is farther from the display section 1 than the position C1 is. When the parallax device 2 is arranged at the position B (t>d), the distance “t” between the display section 1 and the parallax device 2 is designed by the following unified expression. Further, the arrangement interval (arrangement interval of the two adjacent lens elements 23) S of the separation elements in the parallax device 2 is designed by the following unified expression. It is to be noted that FIG. 16 illustrates a case in which n=4, a₁=1, and b=1, FIG. 17 illustrates a case in which n=4, a₂=3, and b=1, FIG. 18 illustrates a case in which n=4, a₃=5, and b=1, FIG. 19 illustrates a case in which n=4, a₄=7, and b=1, and FIG. 20 illustrates a case in which n=4, a₁=1, and b=2.

t=Z·(bn+aₘ)P/{aₘE+(bn+aₘ)P}

S=nE·P/{aₘE+(bn+aₘ)P}

In the above-described expressions, the following is satisfied.

a₂ₘ₋₁=n(m−1)+1

a₂ₘ=nm−1

m=1, 2, 3, . . .

b=1, 2, 3, . . . .

As shown in FIGS. 16 to 20, each lens element 23 at the position B is arranged in each of the intersections of principal rays for the respective perspectives that connect the respective pixels 11 and the respective lens elements 23 at the position C1. In this case, the principal ray is allowed to connect each of the aₘ-number of pixels 11 and each of the b-number of lens elements 23 at the position C1.

### [Effects]

As described above, according to the display unit of the present embodiment, two or more adjacent separation elements are arranged with respect to the adjacent pixels 11 for the n-number of perspectives, and the black matrix 12 is viewed through the separation elements other than the specific separation element. Therefore, the arrangement of the parallax device 2 is allowed to be varied without changing viewing conditions such as the viewing distance. Accordingly, it becomes easy to reduce the thickness and the weight of a unit. Also, on the contrary, when it is difficult to manufacture a device with a reduced thickness due to reasons such as an increase in resolution in the display section 1, it becomes easy to design the whole of the unit to have a large thickness.

### 2. Second Embodiment

Next, a display unit according to a second embodiment will be described. It is to be noted that like numerals are used to designate substantially like components of the display unit according to the first embodiment, and the description thereof is appropriately omitted.

### [General Configuration of Display Unit]

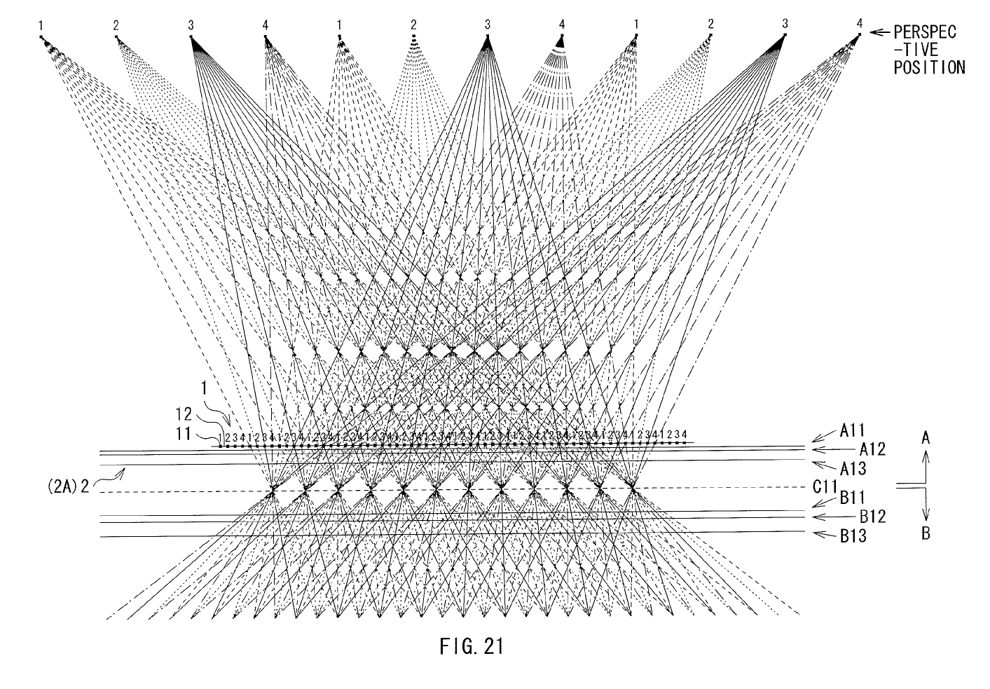

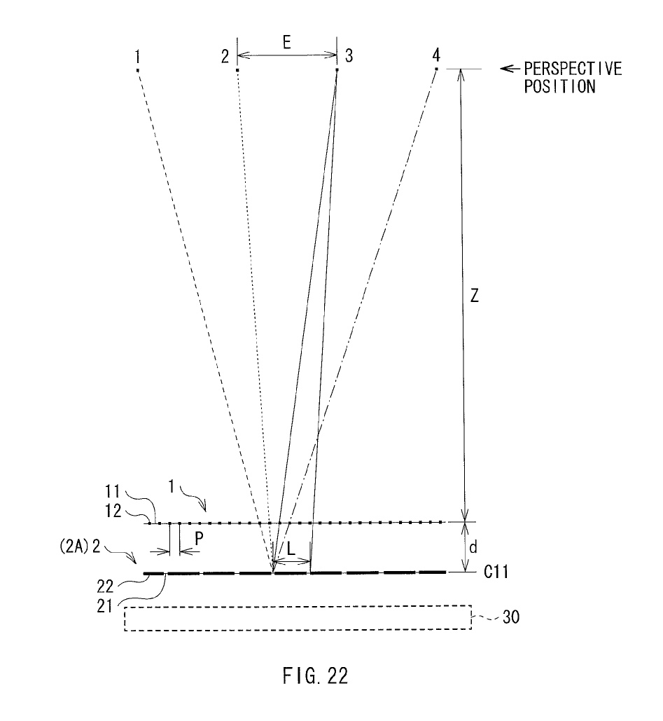

FIG. 21 illustrates a configuration example of a display unit according to the second embodiment of the present disclosure. In FIG. 1, an example (an example of front arrangement) in which the parallax device 2 is arranged on the display surface side (viewing side) of the display section 1 has been shown. However, a configuration (rear arrangement) in which the parallax device 2 is arranged on the opposite side thereof (on the rear face side of the display section 1) as shown in FIG. 21 may be adopted. For example, when a liquid crystal display panel of a backlight scheme is used as the display section 1, the parallax device 2 may be arranged between a backlight 30 (see FIG. 22) and the liquid crystal display panel on the rear face side of the liquid crystal display panel.

Also in the display unit having such a rear arrangement, the arrangement of the parallax device 2 is allowed to be varied without changing viewing conditions such as a viewing distance Z as in the above-described first embodiment. Specifically, the arrangement position of the parallax device 2 may take various forms. In FIG. 21, the arrangement position of the parallax device 2 in a typical design method is shown by C11. Also, examples of the possible arrangement positions in the later-described design method according to the present embodiment are shown by A11, A12, A13, B11, B12, and B13. By the design method according to the present embodiment, the parallax device 2 is allowed to be arranged at a position A that is closer to the display section 1 than the position C11 or at a position B that is farther from the display section 1 than the position C11.

Hereinbelow, the design method of the case of using the parallax barrier 2A as the parallax device 2 is basically described in the present embodiment. However, a similar design method is applicable also to the case of using the lenticular lens 2B, as in the above-described first embodiment.

### [Configuration Example of Parallax Device 2 in Comparative Example (Typical Design Method)]

As a comparative example, description will be given of a configuration example of the parallax device 2 (parallax barrier 2A) in a typical design method in the case of the rear arrangement referring to FIG. 22. In the typical design method, a distance “d” between the display section 1 and the parallax device 2 is designed as follows. Further, an arrangement interval (an arrangement interval between two adjacent opening sections 21, in FIG. 22) L of the separation elements in the parallax device 2 is designed as follows.

d=Z·P/(E−P)

L=nP·E/(E−P)

In the above-described expressions, n is the number of perspectives, Z is the viewing distance, E is the interocular distance, and P is the pixel pitch.

When the distance d and the arrangement interval L are used as design values, one separation element is arranged with respect to the adjacent pixels 11 for the n-number of perspectives. For example, in a case of four perspectives, one opening section 21 is arranged with respect to the adjacent pixels 11 for four perspectives. The respective first to fourth perspective images displayed in the adjacent pixels 11 for four perspectives are separated in directions of different perspective positions by one opening section 21. The plurality of opening sections 21 are arranged. However, all of the opening sections 21 separate, in similar manners, the respective first to fourth perspective images displayed in the corresponding pixels 11 for four perspectives into directions of different perspective positions.

### [Configuration Example of Parallax Device 2 in Design Method According to Present Embodiment]

In contrast to the above-described typical design method, in the design method according to the present embodiment, two or more adjacent separation elements are arranged in correspondence with the adjacent pixels 11 for the n-number of perspectives. Viewed from a specific perspective position, a single specific perspective image is allowed to be viewed through a single specific separation element of the two or more adjacent separation elements. Further, the black matrix 12 that is formed near the adjacent pixels 11 for the n-number of perspectives is allowed to be viewed through separation elements other than the specific separation element. Moreover, the arrangement interval S of the separation elements in the parallax device 2 is set to a value smaller than the above-described arrangement interval L in the typical design method. In other words, the separation elements are arranged in a pitch that is smaller than the pitch in the above-described typical design method.

[Unified Expression in Case of Arranging Parallax Device 2 at Position A (t<d)]

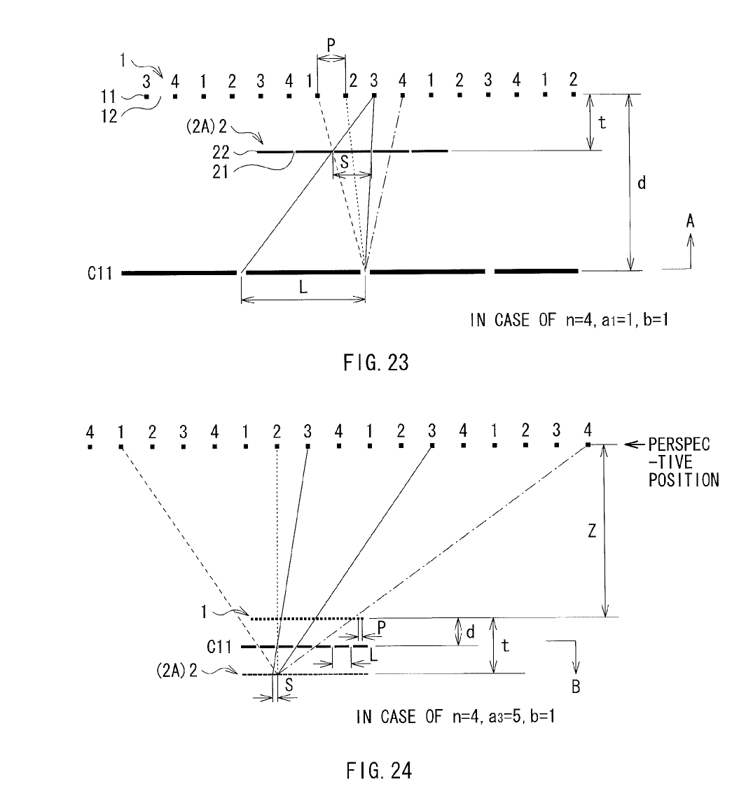

Referring to FIG. 23, description will be given of a unified expression in the design method when the parallax device 2 is arranged at the position A that is closer to the display section 1 than the position C11 is. When the parallax device 2 is arranged at the position A (t<d), the distance “t” between the display section 1 and the parallax device 2 may be designed based on the following unified expression. Further, the arrangement interval (arrangement interval of the two adjacent opening sections 21) S of the separation elements in the parallax device 2 may be designed based on the following unified expression. It is to be noted that FIG. 23 illustrates a case in which n=4, a₁=1, and b=1.

t=Z·aₘP/{(bn+aₘ)E−aₘP}

S=nE·P/{(bn+aₘ)E−aₘP}

In the above-described expressions, the following is satisfied.

a₂ₘ₋₁=n(m−1)+1

a₂ₘ=nm−1

m=1, 2, 3, . . .

b=1, 2, 3, . . . .

As shown in FIG. 23, each opening section 21 at the position A is arranged in each of the intersections of principal rays for the respective perspectives that connect the respective pixels 11 and the respective opening sections 21 at the position C11. In this case, the principal ray is allowed to connect each of the aₘ-number of pixels 11 and each of the b-number of opening sections 21 at the position C11.

[Unified Expression in Case of Arranging Parallax Device 2 at Position B (t>d)]

Referring to FIG. 24, description will be given of a unified expression in the design method when the parallax device 2 is arranged at the position B that is farther from the display section 1 than the position C11 is. When the parallax device 2 is arranged at the position B (t>d), the distance “t” between the display section 1 and the parallax device 2 is designed by the following unified expression. Further, the arrangement interval (arrangement interval of the two adjacent opening sections 21) S of the separation elements in the parallax device 2 may be designed based on the following unified expression. It is to be noted that FIG. 24 illustrates a case in which n=4, a₃=5, and b=1.

t=Z·(bn+aₘ)P/{aₘE−(bn+aₘ)P}

S=nE·P/{aₘE−(bn+aₘ)P}

In the above-described expressions, the following is satisfied.

a₂ₘ₋₁=n(m−1)+1

a₂ₘ=nm−1

m=1, 2, 3, . . .

b=1, 2, 3, . . . .

As shown in FIG. 24, each opening section 21 at the position B is arranged in each of the intersections of principal rays for the respective perspectives that connect the respective pixels 11 and the respective opening sections 21 at the position C11. In this case, the principal ray is allowed to connect each of the aₘ-number of pixels 11 and each of the b-number of opening sections 21 at the position C11.

### 3. Other Embodiments

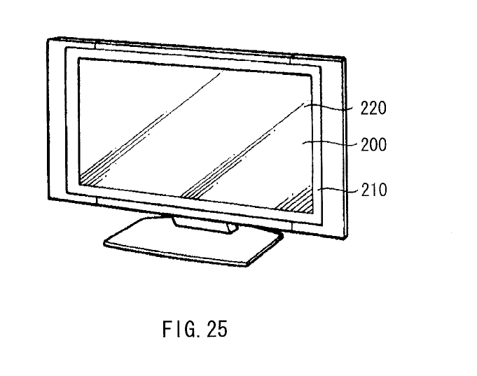

The technology according to the present disclosure is not limited to the above description of the preferred embodiments and may be variously modified. For example, any of the display units according to the above-described preferred embodiments is applicable to various electronic apparatuses that have a display function. FIG. 25 illustrates an appearance configuration of a television as an example of such electronic apparatuses. The television includes an image display screen section 200 that includes a front panel 210 and a filter glass 220.

It is possible to achieve at least the following configurations from the above-described example embodiments of the disclosure.

(1) A display unit including:

a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and

a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another, wherein

a single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.

(2) The display unit according to (1), wherein the parallax device is disposed, at a distance from the display section, on a viewer side of the display section to oppose the display section, the distance being shorter or longer than a value of d represented by following expression,

d=Z·P/(E+P)

where Z is a viewing distance, E is an interocular distance, and P is a pixel pitch.

(3) The display unit according to (1) or (2), wherein the parallax device is arranged, having an arrangement interval of the adjacent separation elements, on a viewer side of the display section to oppose the display section, the arrangement interval being smaller than a value of L represented by following expression,

L=nP·E/(E+P)

where n is number of the perspectives, E is an interocular distance, and P is a pixel pitch.

(4) The display unit according to (1), wherein the parallax device is arranged, at a distance from the display section, on an opposite side of the display section from a viewer to oppose the display section, the distance being shorter or longer than a value of d represented by following expression,

d=Z·P/(E−P)

where Z is a viewing distance, E is an interocular distance, and P is a pixel pitch.

(5) The display unit according to (1) or (4), wherein the parallax device is arranged, having an arrangement interval of the adjacent separation sections, on an opposite side of the display section from a viewer to oppose the display section, the arrangement interval being smaller than a value of L represented by following expression,

L=nP·E/(E−P)

where n is number of the perspectives, E is an interocular distance, and P is a pixel pitch.

(6) The display unit according to any one of (1) to (5), wherein the parallax device is a lenticular lens including a plurality of lens elements that serve as the separation elements.

(7) The display unit according to any one of (1) to (5), wherein the parallax device is a parallax barrier including a plurality of openings that serve as the separation elements.

(8) An electronic apparatus with a display unit, the display unit including:

a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and

a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another, wherein

a single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.

The present application contains subject matter related to that disclosed in Japanese Priority Patent Application JP 2012-174277 filed in the Japan Patent Office on Aug. 6, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and
a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another, wherein
a single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.

2. The display unit according to claim 1, wherein the parallax device is disposed, at a distance from the display section, on a viewer side of the display section to oppose the display section, the distance being shorter or longer than a value of d represented by following expression,
d=Z·P/(E+P)
where Z is a viewing distance, E is an interocular distance, and P is a pixel pitch.

3. The display unit according to claim 1, wherein the parallax device is arranged, having an arrangement interval of the adjacent separation elements, on a viewer side of the display section to oppose the display section, the arrangement interval being smaller than a value of L represented by following expression,
L=nP·E/(E+P)
where n is number of the perspectives, E is an interocular distance, and P is a pixel pitch.

4. The display unit according to claim 1, wherein the parallax device is arranged, at a distance from the display section, on an opposite side of the display section from a viewer to oppose the display section, the distance being shorter or longer than a value of d represented by following expression,
d=Z·P/(E−P)
where Z is a viewing distance, E is an interocular distance, and P is a pixel pitch.

5. The display unit according to claim 1, wherein the parallax device is arranged, having an arrangement interval of the adjacent separation sections, on an opposite side of the display section from a viewer to oppose the display section, the arrangement interval being smaller than a value of L represented by following expression,
L=nP·E/(E−P)
where n is number of the perspectives, E is an interocular distance, and P is a pixel pitch.

6. The display unit according to claim 1, wherein the parallax device is a lenticular lens including a plurality of lens elements that serve as the separation elements.

7. The display unit according to claim 1, wherein the parallax device is a parallax barrier including a plurality of openings that serve as the separation elements.

8. An electronic apparatus with a display unit, the display unit comprising:
a display section including a plurality of pixels and a black matrix formed between the adjacent pixels, and displaying n-number of perspective images having respective perspectives through allocating the n-number of perspective images to n-number of adjacent pixels, respectively, thereby allowing each of the plurality of pixels to be allocated to any one of the n-number of perspective images, where n is an integer of 2 or larger; and
a parallax device including a plurality of separation elements, two or more adjacent separation elements of the plurality of separation elements being arranged in correspondence with the n-number of adjacent pixels, the parallax device separating the n-number of perspective images displayed on the display section into respective n-number of directions that are different from one another, wherein
a single specific separation element of the two or more adjacent separation elements allows a single specific perspective image of the plurality of perspective images to be viewed from a specific perspective position, and rest of the two or more adjacent separation elements allow the black matrix to be viewed from the specific perspective position.
